(19) United States
(12) Patent Application Publication
(10) Pub. No.: US 2007/0204511 A1
(43) Pub. Date: Sep. 6, 2007

(54) Datachable vase for separately filling water and retaining plants

(76) Inventors: Chuan-Jung Lee, Taipei City (TW); Han-Ning Chang, (US)

Correspondence Address: CHUAN-JUNG LEE, 235 Chung-Ho, Box 8-24, Taipei, TW

(21) Appl. No.: 11/366,871

(22) Filed: Mar. 3, 2006

(51) Int. Cl. A01G 9/02

(52) U.S. Cl. 47/66.1; 47/79

(57) ABSTRACT

A detachable vase for separately filling water and retaining plants comprises a lower water-filled bottle body for receiving water; and an upper side of the lower water-filled bottle body having a first connect unit; and an upper bottle body for receiving plants or flowers; the upper connect unit connected to the lower water-filled bottle body; a lower side of the upper bottle body having a second connect unit which can be engaged to the first connect unit. The upper bottle body includes at least two sub-bodies which are engageable to one another. The vase is divided into a first and a second bottle bodies. The lower water-filled bottle body is detachable from the upper bottle body. When it is desired to update the water in the vase, it is only necessary to detach the lower water-filled bottle body from the upper bottle body.

### FIELD OF THE INVENTION

The present invention relates to vases, and in particular to a detachable vase for separately filling water and retaining plants, wherein a lower water-filled bottle body serves for receiving water; and an upper bottle body serves for receiving plants or flowers. If it is desired to update water in the vase, the upper bottle can be taken out from the lower bottle, while the plants still remains in the upper bottle with the original arrangement.

### BACKGROUND OF THE INVENTION

In the prior art vase for receiving plants or flowers, the vase is an integral body. The plants or flowers are received in the vase from an opening of the vase and water is also filled into the vase from the opening of the vase. When it is desired to update water in the vase, the user must take the flower or plants from the vase and then pour the water from the vase. However, the operation is inconvenient. Thereby the arrangement of the flower and plants in the vase become an art. Generally, it has predetermined arrangements which may be made by a flower arrangement artist. Thereby the operation of taking the flower from the vase will destroy the arrangement of the flower and plants.

Therefore, there is an eager demand for improving this prior art defect.

### SUMMARY OF THE INVENTION

Accordingly, the primary object of the present invention is to provide a detachable vase for separately filling water and retaining plants, wherein in the present invention, the vase is divided into a first and a second bottle bodies. The lower water-filled bottle body is detachable from the upper bottle body. When it is desired to update the water in the vase, it is only necessary to detach the lower water-filled bottle body from the upper bottle body. The arrangement of the flowers and plants in the vase is unchangeable so that the user is unnecessary to arrange the flower and plants again. Thereby the upper bottle body can include other sub-bodies so that the user can select the desired sub-bottle bodies to form a desire shape and pattern.

To achieve above objects, the present invention provides a detachable vase which comprises a lower water-filled bottle body for receiving water; and an upper side of the lower water-filled bottle body having a first connect unit; and an upper bottle body for receiving plants or flowers; the upper connect unit connected to the lower water-filled bottle body; a lower side of the upper bottle body having a second connect unit which can be engaged to the first connect unit. The upper bottle body includes at least two sub-bodies which are engageable to one another. The vase is divided into a first and a second bottle bodies.

The various objects and advantages of the present invention will be more readily understood from the following detailed description when read in conjunction with the appended drawing.

### BRIEF DESCRIPTION OF THE DRAWINGS

FIGS. 1 and 1A are the cross sectional view and a perspective view showing the embodiment of the present invention.

FIG. 2 shows that the vase has a transparent area for viewing the level of water within the vase.

FIG. 3 shows the first example about the first and second connecting unit.

FIG. 4 shows the second example about the first and second connecting unit.

FIG. 5 shows that the upper bottle body of the present invention can be formed of a plurality of sub-bodies.

FIG. 6 shows another embodiment of the present invention, wherein the upper bottle of the present invention is divided into two parts.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

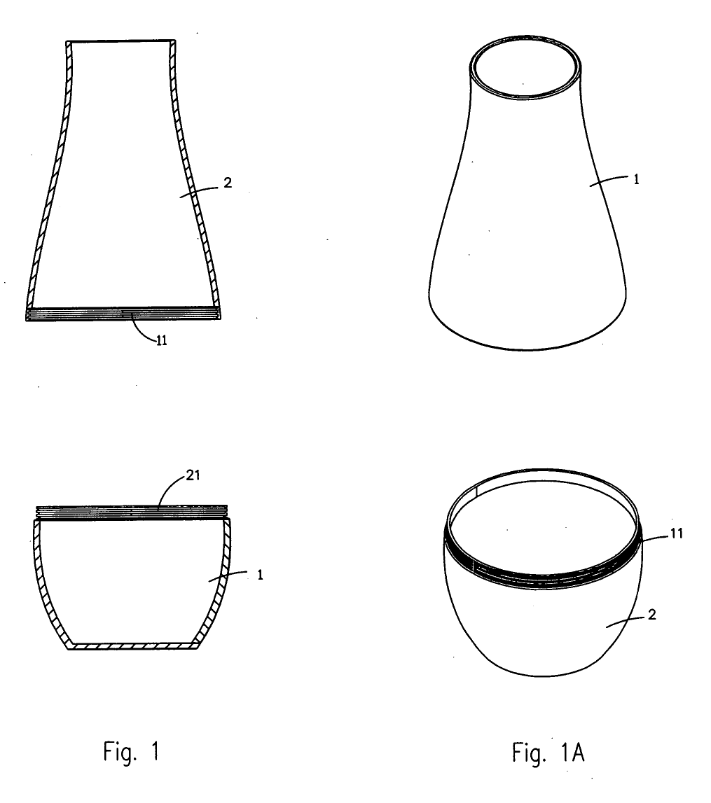

Referring to FIG. 1, the structure of the vase of the first embodiment of the present invention is illustrated. The detachable vase 100 of the present invention has the following elements.

Referring to FIGS. 1 and 1A, a lower water-filled bottle body 1 serves for receiving water. An upper side of the lower base has a first connecting unit 11.

An upper bottle body 2 can be connected to the lower water-filled bottle body 1. A lower side of the upper bottle body has a second connecting unit 21 which can be engaged to the first connecting unit 11.

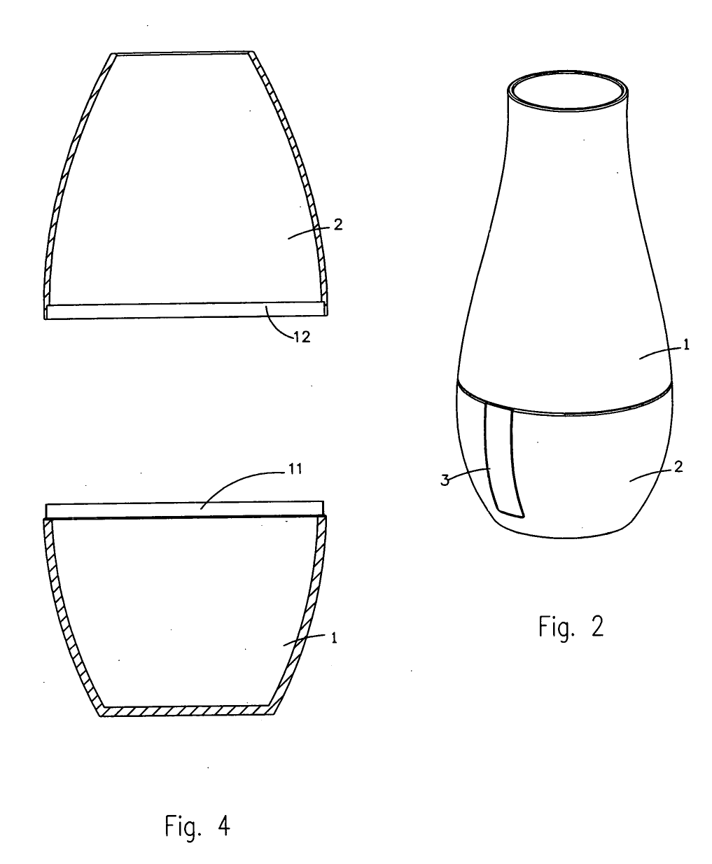

Referring to FIG. 2, in one use of the present invention, if the vase is not made of transparent material. The vase may be installed with a transparent area 3 for viewing the level of water within the vase.

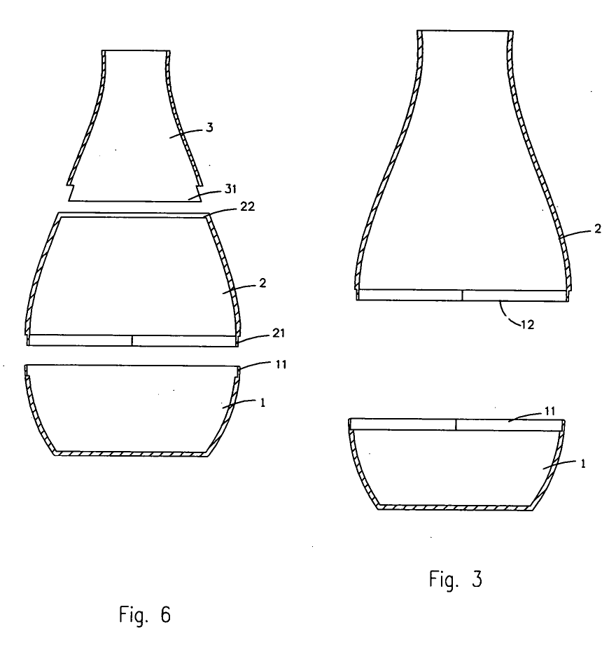

In the present invention, the first and second connecting units 1, 2 may have different forms. For example, in FIG. 1, it is illustrated that the first and second connecting units 11, 2 are threaded. In FIG. 3, the second connecting unit 21 of the upper bottle 2 has an outer diameter slightly smaller than that of an inner diameter of the first connecting unit 1 so that the upper bottle body 2 can be inserted into the second connecting unit 2 of the lower water-filled bottle body 1 to be tightly engaged within the lower water-filled bottle body 1. However in this example, it can be designed that the outer diameter of the first connecting unit 11 is slightly smaller than an inner diameter of the second connecting unit 21 so that the first connecting unit 11 is inserted into the second connecting unit 21 tightly.

Application of the present invention will be described herein. In use, the flower can be inserted into the vase and water is filled into the vase. However the water level is not over an upper edge of the lower water-filled bottle body 1. When it is desired to update the water with fresh water, the upper bottle body 2 can be withdrawn from the lower bottle body 1 to be put aside. Then the water in the lower water-filled bottle body 1 can be updated by fresh water. Then the upper bottle body 2 is engaged to the lower water filled bottle body 1 again. Thereby the present invention provides a convenient way for updating water in the vase, while the flowers are unnecessary to be withdrawn from the vase. Thereby the original form of the flowers can be retained. Users are not necessary to arrange the flower again and again.

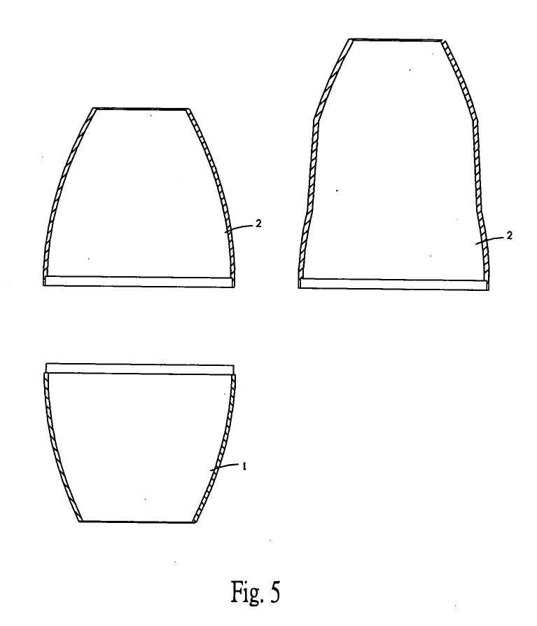

Referring to FIG. 5, it is illustrated that in the present invention, they may be a plurality of second bottle bodies 2 which have the same specification of the second connecting unit 21 so that these bottle bodies 2 can be suitable for the same lower water-filled bottle body 1. Thereby the lower water-filled bottle body 1 can be used with various kinds of upper bottle bodies 2. Thus, the user can select a desired one, and the manufacturer can be made many kinds of the lower water-filled bottle body 1 and upper bottle body 2 which are matched one another. Thereby if one of the lower water-filled bottle body 1 or the upper bottle body 2 is destroyed, the user can update the destroyed one with a new one so as to save cost.

Referring to FIG. 6, another embodiment of the present invention is illustrated. In this embodiment, the vase 200 is divided into three parts, a lower water-filled bottle body 1, a second bottle body 2, and a third bottle body 3. The lower water-filler bottle body 1 has a first connecting unit 11. The second bottle body has a second connecting unit 21 and a third connecting unit 22. The third bottle body 3 has a third connecting unit 31. Thereby first connecting unit 11 of the lower water-filled bottle body 1 can be engaged to the second connecting unit 21 of the second bottle body 2. The third connecting unit 22 of the second bottle body 2 can be engaged to the fourth connecting unit 31 of the third bottle body 3 so as to from a vase 200.

In this embodiment, the lower water-filled bottle body can be used to fill water. The second and third bottle bodies 2 and 3 are used as decorations so that the user can select desired assemblies to form a vase with a desired outlook.

However as above mentioned, the connecting units 11, 21, 22 and 31 may have different forms, such as threaded sections, buckles, etc. All these are within the scope of the present invention. Furthermore, the parts of the bottle bodies of the vase in FIG. 6 are not confined to two or three. Other numbers are permissible in the present invention. All these are within the scope of the present invention.

Advantages of the present invention will be described herein. In the present invention, the vase is divided into a first and a second bottle bodies. The lower water-filled bottle body is detachable from the upper bottle body. When it is desired to update the water in the vase, it is only necessary to detach the lower water-filled bottle body from the upper bottle body. The arrangement of the flowers and plants in the vase in unchangeable so that the user is unnecessary to arrange the flower and plants again. Furthermore, the upper bottle body can include other sub-bodies so that the user can select the desired sub-bottle bodies to form a desire shape and pattern.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A detachable vase for separately filling water and retaining plants comprising:
a lower water-filled bottle body for receiving water; and an upper side of the lower water-filled bottle body having a first connect unit; and
an upper bottle body for receiving plants or flowers; the upper bottle body connected to the lower water-filled bottle body; a lower side of the upper bottle body having a second connect unit which can be engaged to the first connect unit;

2. (canceled)

3. The detachable vase for separately filling water and retaining plants as claimed in claim 1, wherein the first and second connect units are formed with threads.

4. The detachable vase for separately filling water and retaining plants as claimed in claim 1, wherein the second connect unit has an outer diameter slightly smaller than an inner diameter of the first connect unit so that the upper bottle body can be inserted into the second connect unit of the lower water-filled bottle body so as to be tightly engaged within the lower water-filled bottle body.

5. The detachable vase for separately filling water and retaining plants as claimed in claim 1, wherein the outer diameter of the first connect unit is slightly smaller than an inner diameter of the second connect unit so that the first connect unit is inserted into the second connect unit tightly.

6. The detachable vase for separately filling water and retaining plants as claimed in claim 1, wherein the upper bottle body includes at least two sub-bodies which are engageable to one another.

7-10. (canceled)
